(19) United States
(12) Patent Application Publication
(10) Pub. No.: US 2018/0030259 A1
(43) Pub. Date: Feb. 1, 2018

(54) POLYMER BLENDS COMPRISING POLYMETHYL METHACRYLATE AND POLYCARBONATE

(71) Applicant: SABIC Global Technologies B.V., Bergen op Zoom (NL)

(72) Inventors: Elango SOMASUNDARAM, Bangalore (IN); Rajendra Kashinath SINGH, Lompoc, CA (US); Tariq SYED, Riyadh (SA); Abdullah Shamroukh AL-OTAIBI, Riyadh (SA)

(21) Appl. No.: 15/552,352

(22) PCT Filed: Feb. 25, 2016
(86) PCT No.: PCT/US2016/019530

§ 371 Date: Aug. 21, 2017

(30) Foreign Application Priority Data
Feb. 26, 2015 (EP) 15382082.4

(51) Int. Cl. C08L 33/12; C08J 5/00

(52) U.S. Cl. CPC C08L 33/12; C08J 5/00; C08L 2201/10; C08L 2205/05; C08J 2333/12; C08J 2469/00

(57) ABSTRACT

The disclosure concerns transparent polymer blends derived from melt extrusion of (i) 9.9 to 40 weight percent polycarbonate; (ii) 59.9 to 90 weight percent polymethyl methacrylate; and (iii) 0.0025 to 0.1 weight percent of catalyst; wherein said polymer is transparent.

### RELATED APPLICATIONS

This application claims benefit of European Patent Application No. 15382082.4 filed Feb. 26, 2015, the description of which is incorporated herein in its entirety.

### TECHNICAL FIELD

The disclosure concerns melt extrusion of a polymer comprising polycarbonate and polymethylmethacrylate (PMMA) and polycarbonate (PC), the product of the extrusion and articles formed from the polymer.

### BACKGROUND

Polymethyl methacrylate (PMMA) has high transparency (equivalent to glass), surface hardness, low birefringence, good UV resistance, good weatherability and chemical resistance. Compared to polycarbonate (PC), it is easier to process and lower in cost. On the negative side, PMMA has relatively poor dimensional stability, low impact strength (brittle), and low temperature stability.

Polycarbonate exhibits high temperature stability, good dimensional stability, high impact strength, good modulus, and good transparency. There is a need, however, to improve properties such as scratch resistance, UV resistance, chemical resistance, and stress birefringence.

Creating blends of PMMA and PC is problematic. It is known that melt blends of PC and PMMA are not thermodynamically miscible resulting in loss of transparency (opaque) which makes the blend not suitable for optical applications.

There is a need in the art for transparent polymers that overcome the above deficiencies.

### SUMMARY

The disclosure concerns transparent polymer blends derived from melt extrusion of (i) 9.9 to 40 weight percent polycarbonate, (ii) 59.9 to 90 weight percent polymethyl methacrylate, and (iii) 0.0025 to 0.1 weight percent of catalyst.

The disclosure also concerns methods for forming transparent polymer blends comprising melt extrusion of (i) 9.9 to 40 weight percent polycarbonate; (ii) 59.9 to 90 weight percent polymethyl methacrylate; and (iii) 0.0025 to 0.1 weight percent of catalyst.

### DETAILED DESCRIPTION OF ILLUSTRATIVE EMBODIMENTS

The present invention provides for a transparent blend of polymethylmethacrylate and polycarbonate polymers. Achieving transparency from a combination of polymers that would not normally be transparent is achieved by melt extrusion of (i) 9.9 to 40 weight percent polycarbonate, (ii) 59.9 to 90 weight percent polymethyl methacrylate, and (iii) 0.0025 to 0.1 weight percent of catalyst. In that respect the term “melt extrusion” should be understood to be equivalent to “reactive melt extrusion”. Without willing to be bound to it the present inventors believe that the catalyst, during the melt extrusion, allows transesterification reactions to occur that favor the formation of a stable blend of the polycarbonate and the polymethyl methacrylate.

### Polycarbonate Polymer

The terms “polycarbonate” or “polycarbonates” as used herein includes copolycarbonates, homopolycarbonates and (co)polyester carbonates.

The term polycarbonate can be further defined as compositions have repeating structural units of the formula (1):

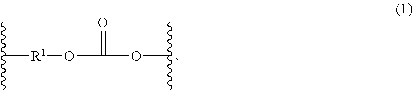

in which at least 60 percent of the total number of R1 groups are aromatic organic radicals and the balance thereof are aliphatic, alicyclic, or aromatic radicals. In a further aspect, each R1 is an aromatic organic radical and, more preferably, a radical of the formula (2):

−A1−Y1−A2− (2).

wherein each of A1 and A2 is a monocyclic divalent aryl radical and Y1 is a bridging radical having one or two atoms that separate A1 from A2. In various aspects, one atom separates A1 from A2. For example, radicals of this type include, but are not limited to, radicals such as —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y1 is preferably a hydrocarbon group or a saturated hydrocarbon group such as methylene, cyclohexylidene, or isopropylidene. Polycarbonate materials include materials disclosed and described in U.S. Pat. No. 7,786,246, which is hereby incorporated by reference in its entirety for the specific purpose of disclosing various polycarbonate compositions and methods for manufacture of the same.

It is preferred that the polycarbonate is substantially free of halogen atoms. By “substantially free” it is intended that less than 1 wt % of the polycarbonate comprises halogen atoms.

In some embodiments a melt polycarbonate product may be utilized. The melt polycarbonate process is based on continuous reaction of a dihydroxy compound and a carbonate source in a molten stage. The reaction can occur in a series of reactors where the combined effect of catalyst, temperature, vacuum, and agitation allows for monomer reaction and removal of reaction by-products to displace the reaction equilibrium and effect polymer chain growth. A common polycarbonate made in melt polymerization reactions is derived from bisphenol A (BPA) via reaction with diphenyl carbonate (DPC). This reaction can be catalyzed by, for example, tetra methyl ammonium hydroxide (TMAOH) or tetrabutyl phosphonium acetate (TBPA), which can be added in to a monomer mixture prior to being introduced to a first polymerization unit and sodium hydroxide (NaOH), which can be added to the first reactor or upstream of the first reactor and after a monomer mixer.

A polycarbonate according to the present disclosure may (but this is not a requirement) comprise less than or equal to 33 parts per billion by weight (ppb), specifically less than or equal to 20 ppb of molybdenum; less than or equal to 33 ppb, specifically less than or equal to 20 ppb vanadium; less than or equal to 33 ppb, specifically less than or equal to 20 ppb chromium; less than or equal to 75 ppb, specifically less than or equal to 50 ppb titanium; less than or equal to 375 ppb, specifically less than or equal to 250 ppb of niobium; less than or equal to 33 ppb, specifically less than or equal to 20 ppb of nickel; less than or equal to 10 ppb, specifically less than or equal to 5 ppb zirconium; less than or equal to 10 ppb, specifically less than or equal to 5 ppb of iron. Further details are found in European applications 13382087.8 and 13382085.2, both of which applications are incorporated herein by reference in their entireties for any and all purposes. Without being bound to any particular theory, the foregoing purity levels of the diaryl carbonate or the polycarbonate may influence the transparency, color, or both of the polycarbonate product.

In certain embodiments, polycarbonate produced by interfacial polymerization may be utilized. In some processes, bisphenol A and phosgene are reacted in an interfacial polymerization process. Typically, the disodium salt of bisphenol A is dissolved in water and reacted with phosgene which is typically dissolved in a solvent that not miscible with water (such as a chlorinated organic solvent like methylene chloride).

### Polymethyl Methacrylate Polymer

The term “polymethyl methacrylate” (or PMMA) is synonymous with the terms poly(methyl 2-methylpropanoate) and poly(methyl methacrylate). As used herein, the term includes homopolymers as well as copolymers of methyl methacrylate and other acrylic monomers, such as for example, ethyl acrylate, and glycidyl methacrylate in which the other acrylic monomer is present to the extent of up to 35% by weight of the composition. The polymethyl methacrylate may be stabilized with ultraviolet and thermal stabilizers and may include other additives discussed herein.

### Catalyst

Any suitable transesterification catalyst may be used with the invention. Some preferred catalysts are tin catalysts. One preferred tin catalyst is dibutyl tin dilaurate. While any amount of catalyst that accomplishes forming a transparent blend may be used, it is preferred that the amount of catalyst is 0.01 to 0.1 weight percent of the polymer blend. Even more preferred, the amount of catalyst is 0.01 to 0.04 weight percent of the polymer blend.

### Additional Components

The additive composition can include an impact modifier, flow modifier, filler (e.g., a particulate polytetrafluoroethylene (PTFE), glass, carbon, mineral, or metal), reinforcing agent (e.g., glass fibers), antioxidant, heat stabilizer, light stabilizer, ultraviolet (UV) light stabilizer, UV absorbing additive, plasticizer, lubricant, release agent (such as a mold release agent), antistatic agent, anti-fog agent, antimicrobial agent, colorant (e.g., a dye or pigment), surface effect additive, radiation stabilizer, flame retardant, anti-drip agent (e.g., a PTFE-encapsulated styrene-acrylonitrile copolymer (TSAN)), or a combination comprising one or more of the foregoing. For example, a combination of a heat stabilizer, mold release agent, and ultraviolet light stabilizer can be used. In general, the additives are used in the amounts generally known to be effective. For example, the total amount of the additive composition (other than any impact modifier, filler, or reinforcing agent) can be 0.001 to 10.0 wt %, or 0.01 to 5 wt %, each based on the total weight of the polymer in the composition.

The transparent polymer blend can include various additives ordinarily incorporated into polymers of this type, with the proviso that the additive(s) are selected so as to not significantly adversely affect the desired properties of the thermoplastic composition (good compatibility for example). Such additives can be mixed at a suitable time during the mixing of the components for forming the composition. The additives may be added during the melt extrusion provided the additives do not inhibit or significantly affect the efficiency of the desired reaction as catalyzed by the catalyst. The additives may also be added in a second melt mixing step.

Examples of impact modifiers include natural rubber, fluoroelastomers, ethylene-propylene rubber (EPR), ethylene-butene rubber, ethylene-propylene-diene monomer rubber (EPDM), acrylate rubbers, hydrogenated nitrile rubber (HNBR), silicone elastomers, styrene-butadiene-styrene (SBS), styrene-butadiene rubber (SBR), styrene-(ethylene-butene)-styrene (SEBS), acrylonitrile-butadiene-styrene (ABS), acrylonitrile-ethylene-propylene-diene-styrene (AES), styrene-isoprene-styrene (SIS), styrene-(ethylene-propylene)-styrene (SEPS), methyl methacrylate-butadiene-styrene (MBS), high rubber graft (HRG), and the like. Some suitable impact modifiers include PC (polycarbonate)/ABS (such as cycoloy PC/ABS) and MBS type formulations.

Heat stabilizer additives include organophosphites (e.g. triphenyl phosphite, tris-(2,6-dimethylphenyl)phosphite, tris-(mixed mono-and di-nonylphenyl)phosphite or the like), phosphonates (e.g., dimethylbenzene phosphonate or the like), phosphates (e.g., trimethyl phosphate, or the like), or combinations comprising at least one of the foregoing heat stabilizers. The heat stabilizer can be tris(2,4-di-t-butylphenyl) phosphate available as IRGAPHOS™ 168. Heat stabilizers are generally used in amounts of 0.01 to 5 wt %, based on the total weight of polymer in the composition.

There is considerable overlap among plasticizers, lubricants, and mold release agents, which include, for example, glycerol tristearate (GTS), phthalic acid esters (e.g., octyl-4,5-epoxy-hexahydrophthalate), tris-(octoxycarbonylethyl)isocyanurate, tristearin, di- or polyfunctional aromatic phosphates (e.g., resorcinol tetraphenyl diphosphate (RDP), the bis(diphenyl) phosphate of hydroquinone and the bis(diphenyl) phosphate of bisphenol A); poly-alpha-olefins; epoxidized soybean oil; silicones, including silicone oils (e.g., poly(dimethyl diphenyl siloxanes); esters, for example, fatty acid esters (e.g., alkyl stearyl esters, such as, methyl stearate, stearyl stearate, and the like), waxes (e.g., beeswax, montan wax, paraffin wax, or the like), or combinations comprising at least one of the foregoing plasticizers, lubricants, and mold release agents. These are generally used in amounts of 0.01 to 5 wt %, based on the total weight of the polymer in the composition.

Light stabilizers, in particular ultraviolet light (UV) absorbing additives, also referred to as UV stabilizers, include hydroxybenzophenones (e.g., 2-hydroxy-4-n-octoxy benzophenone), hydroxybenzotriazines, cyanoacrylates, oxanilides, benzoxazinones (e.g., 2,2′-(1,4-phenylene)bis(4H-3,1-benzoxazin-4-one, commercially available under the trade name CYASORB UV-3638 from Cytec), aryl salicylates, hydroxybenzotriazoles (e.g., 2-(2-hydroxy-5-methylphenyl)benzotriazole, 2-(2-hydroxy-5-tert-octylphenyl)benzotriazole, and 2-(2H-benzotriazol-2-yl)-4-(1,1,3,3-tetramethylbutyl)-phenol, commercially available under the trade name CYASORB 5411 from Cytec) or combinations comprising at least one of the foregoing light stabilizers. The UV stabilizers can be present in an amount of 0.01 to 1 wt %, specifically, 0.1 to 0.5 wt %, and more specifically, 0.15 to 0.4 wt %, based upon the total weight of polymer in the composition.

Possible fillers or reinforcing agents include, for example, mica, clay, feldspar, quartz, quartzite, perlite, tripoli, diatomaceous earth, aluminum silicate (mullite), synthetic calcium silicate, fused silica, fumed silica, sand, boron-nitride powder, boron-silicate powder, calcium sulfate, calcium carbonates (such as chalk, limestone, marble, and synthetic precipitated calcium carbonates) talc (including fibrous, modular, needle shaped, and lamellar talc), wollastonite, hollow or solid glass spheres, silicate spheres, cenospheres, aluminosilicate or (armospheres), kaolin, whiskers of silicon carbide, alumina, boron carbide, iron, nickel, or copper, continuous and chopped carbon fibers or glass fibers, molybdenum sulfide, zinc sulfide, barium titanate, barium ferrite, barium sulfate, heavy spar, TiO₂, aluminum oxide, magnesium oxide, particulate or fibrous aluminum, bronze, zinc, copper, or nickel, glass flakes, flaked silicon carbide, flaked aluminum diboride, flaked aluminum, steel flakes, natural fillers such as wood flour, fibrous cellulose, cotton, sisal, jute, starch, lignin, ground nut shells, or rice grain husks, reinforcing organic fibrous fillers such as poly(ether ketone), polyimide, polybenzoxazole, poly(phenylene sulfide), polyesters, polyethylene, aromatic polyamides, aromatic polyimides, polyetherimides, polytetrafluoroethylene, and poly(vinyl alcohol), as well combinations comprising at least one of the foregoing fillers or reinforcing agents. The fillers and reinforcing agents can be coated with a layer of metallic material to facilitate conductivity, or surface treated with silanes to improve adhesion and dispersion with the polymer matrix. Fillers are used in amounts of 1 to 200 parts by weight, based on 100 parts by weight of based on 100 parts by weight of the total composition.

Antioxidant additives include organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite; alkylated monophenols or polyphenols; alkylated reaction products of polyphenols with dienes, such as tetrakis[methylene(3,5-di-tert-butyl-4-hydroxyhydrocinnamate)] methane; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate; amides of beta-(3,5-di-tert-butyl-4-hydroxyphenyl)-propionic acid, or combinations comprising at least one of the foregoing antioxidants. Antioxidants are used in amounts of 0.01 to 0.1 parts by weight, based on 100 parts by weight of the total composition, excluding any filler.

Useful flame retardants include organic compounds that include phosphorus, bromine, and/or chlorine. Non-brominated and non-chlorinated phosphorus-containing flame retardants can be preferred in certain applications for regulatory reasons, for example organic phosphates and organic compounds containing phosphorus-nitrogen bonds.

Inorganic flame retardants can also be used, for example salts of C₁₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate; salts such as Na₂CO₃, K₂CO₃, MgCO₃, CaCO₃, and BaCO₃, or fluoro-anion complexes such as Li₃AlF₆, BaSiF₆, KBF₄, K₃AlF₆, KAlF₄, K₂SiF₆, and/or Na₃AlF₆. When present, inorganic flame retardant salts are present in amounts of 0.01 to 10 parts by weight, more specifically 0.02 to 1 parts by weight, based on 100 parts by weight of the total composition, excluding any filler.

Anti-drip agents can also be used in the composition, for example a fibril forming or non-fibril forming fluoropolymer such as polytetrafluoroethylene (PTFE). The anti-drip agent can be encapsulated by a rigid copolymer, for example styrene-acrylonitrile copolymer (SAN). PTFE encapsulated in SAN is known as TSAN. A TSAN comprises 50 wt % PTFE and 50 wt % SAN, based on the total weight of the encapsulated fluoropolymer. The SAN can comprise, for example, 75 wt % styrene and 25 wt % acrylonitrile based on the total weight of the copolymer. Antidrip agents can be used in amounts of 0.1 to 10 parts by weight, based on 100 parts by weight of the total composition, excluding any filler.

Certain polycarbonates used in the invention can be manufactured by various methods known in the art. For example, powdered polycarbonate, and other optional components are first blended, optionally with any fillers, in a high speed mixer or by hand mixing. The blend is then fed into the throat of a twin-screw extruder via a hopper. Alternatively, at least one of the components can be incorporated into the composition by feeding it directly into the extruder at the throat and/or downstream through a sidestuffer, or by being compounded into a masterbatch with a desired polymer and fed into the extruder. The extruder is generally operated at a temperature higher than that necessary to cause the composition to flow. The extrudate can be immediately quenched in a water bath and pelletized.

### Polymer Composition and Extrusion

Some compositions comprise polymer derived from melt extrusion of (i) 9.9 to 40 weight percent polycarbonate; (ii) 59.9 to 90 weight percent polymethyl methacrylate; and (iii) 0.0025 to 0.1 weight percent of catalyst; wherein the polymer is transparent.

Certain compositions comprise polymer comprises (i) 9.9 to 30 weight percent polycarbonate; (ii) 69.9 to 90 weight percent polymethyl methacrylate; and (iii) 0.0025 to 0.04 weight percent of catalyst.

The polymer compositions may additionally contain additives as described herein.

The polymer compositions can be formed by techniques known to those skilled in the art. Extrusion and mixing techniques, for example, may be utilized to combine the components of the polymer composition.

In certain embodiments, extruding is performed using a twin screw extruder. Some extrusions are performed at around 260° C. In some embodiments, the extruder has a plurality of heated zones. In some processes, melt extrusion utilizes a screw extruder operating at a speed of at least 100 rpm.

In some preferred embodiments, at least a portion of the polycarbonate and the polymethyl methacrylate react during melt extrusion.

### Articles of Manufacture

In one aspect, the present invention pertains to shaped, formed, or molded articles comprising the transparent polymer blends described herein. The compositions can be molded into useful shaped articles by a variety of means such as injection molding, extrusion, rotational molding, blow molding and thermoforming to form articles. The compositions described herein can also be made into film and sheet as well as components of laminate systems. In a further aspect, a method of manufacturing an article comprises melt blending the polycarbonate component, polymethyl methacrylate, catalyst and any optional components; and molding the extruded composition into an article. In a still further aspect, the extruding is done with a twin-screw extruder.

In a further aspect, the article comprising the disclosed transparent polymer blends is used in automotive applications. In a still further aspect, the article can be selected from computer and business machine housings such as housings for monitors, handheld electronic device housings such as housings for cell phones, electrical connectors, medical devices, membrane devices, and components of lighting fixtures, ornaments, home appliances, roofs, greenhouses, sun rooms, swimming pool enclosures, and the like. Other representative articles that may be fabricated using the disclosed copolymer compositions provided herein include headlamp bezels, headlamps, tail lamps, tail lamp housings, tail lamp bezels, license plate enclosures, enclosures for electrical and telecommunication devices, building and construction applications such as glazing, roofs, windows, floors, decorative window furnishings or treatments; treated glass covers for pictures, paintings, posters, and like display items; optical lenses; ophthalmic lenses; corrective ophthalmic lenses; implantable ophthalmic lenses; wall panels, and doors; protected graphics; outdoor and indoor signs; enclosures, housings, panels, and parts for automatic teller machines (ATM); enclosures, computer housings; desk-top computer housings; portable computer housings; lap-top computer housings; palm-held computer housings; monitor housings; printer housings; keyboards; FAX machine housings; copier housings; telephone housings; mobile phone housings; radio sender housings; radio receiver housings; light fixtures; lighting appliances; network interface device housings; and like applications. In a still further aspect, the article used in automotive applications is selected from instrument panels, overhead consoles, interior trim, center consoles, headlamp bezels, headlamps, tail lamps, tail lamp housings, tail lamp bezels, license plate enclosures, steering wheels, radio speaker grilles, mirror housings, grille opening reinforcements, steps, hatch covers, knobs, buttons, and levers. Additional fabrication operations may be performed on articles, such as, but not limited to molding, in-mold decoration, baking in a paint oven, lamination, and/or thermoforming.

In various aspects, the article comprising the transparent polymer blends are suitable for use in applications such as transparent keypads for mobile phones, where customers require the possibility to form these films at low temperatures (below 100° C.) and further require an improved punch ductility and chemical resistance. Other typical such articles are automotive trim, automotive interior parts, portable telecommunications and appliance fronts. In a further aspect, wherein the article is a film, it can further comprise visual effects pigments (such as coated Al and glass flakes. In a still further aspect, the article is a film comprising a disclosed copolymer composition can be used in direct film applications but also in processes like IMD (In Mould Decoration). In an even further aspect, the article comprising a disclosed copolymer composition is used in lighting applications including automotive headlamp lenses, covers and lenses for other optical devices, as well as transparent films and sheets. The article can also be used in a wide variety of molded products such as medical devices, radio and TV bezels, mobile phone keypads, notebook computer housings and keys, optical display films, automotive parts, and other electronic and consumer products.

### Aspects

The present disclosure comprises at least the following aspects.

Aspect 1. A transparent polymer blend comprising a polymer derived from melt extrusion of (i) 9.9 to 40 weight percent polycarbonate; (ii) 59.9 to 90 weight percent polymethyl methacrylate; and (iii) 0.0025 to 0.1 weight percent of catalyst; wherein the polymer is transparent, and wherein the combined weight percent value of all polymer blend components does not exceed 100 wt. %, and wherein all weight percent values are based on the total weight of the polymer blend.

Aspect 2. The transparent polymer blend of aspect 1, wherein the catalyst comprises tin.

Aspect 3. The transparent polymer blend of aspect 1, wherein the catalyst is dibutyl tin dilaurate.

Aspect 4. The transparent polymer blend of aspect 1, wherein said polycarbonate is substantially free of halogen atoms.

Aspect 5. The transparent polymer blend of any one of aspects 1-4, wherein the polymer comprises (i) 9.9 to 30 weight percent polycarbonate; (ii) 69.9 to 90 weight percent polymethyl methacrylate; and (iii) 0.0025 to 0.04 weight percent of catalyst, and wherein the combined weight percent value of all components does not exceed 100 wt. %, and wherein all weight percent values are based on the total weight of the polymer blend.

Aspect 6. The transparent polymer blend of any one of aspects 1-5, wherein transesterification occurs with at least a portion of the polycarbonate and the polymethyl methacrylate during melt extrusion.

Aspect 7. The transparent polymer blend of any one of aspects 1-7, wherein the transparent polymer blend additionally comprises one or more of impact modifier, flow modifier, filler, reinforcing agent, antioxidant, heat stabilizer, light stabilizer, ultraviolet light stabilizer, ultraviolet absorbing additive, plasticizer, lubricant, release agent, antistatic agent, anti-fog agent, antimicrobial agent, colorant, surface effect additive, radiation stabilizer, flame retardant, and anti-drip agent.

Aspect 8. The transparent polymer blend of any one of aspects 1-7, wherein the polycarbonate is derived from the melt polymerization of bisphenol A with diphenyl carbonate.

Aspect 9. The transparent polymer blend of any one of claims 1-8, wherein the polycarbonate comprises less than or equal to 33 ppb of molybdenum; less than or equal to 33 ppb of vanadium; less than or equal to 33 ppb of chromium; less than or equal to 75 ppb of titanium; less than or equal to 375 ppb of niobium; less than or equal to 33 ppb of nickel; less than or equal to 10 ppb of zirconium; less than or equal to 10 ppb iron; or any combination of the foregoing.

Aspect 10. The transparent polymer blend of any one of aspects 1-9, wherein the polymer additionally comprises additionally comprising one or more additives selected from flame retardants, anti-drip agent, antioxidant, antistatic agent, chain extender, colorant, de-molding agent, dye, flow promoter, flow modifier, light stabilizer, lubricant, mold release agent, pigment, quenching agent, thermal stabilizer, UV absorbent substance, UV reflectant substance, and UV stabilizer.

Aspect 11. A method of forming an article comprising: (a) melt extrusion of (i) 9.9 to 40 weight percent polycarbonate; (ii) 59.9 to 90 weight percent polymethyl methacrylate; and (iii) 0.0025 to 0.1 weight percent of catalyst to produce a transparent polymer blend; and (b) molding the polymer blend into said article, and wherein the combined weight percent value of all components does not exceed 100 wt. %, and wherein all weight percent values are based on the total weight of the article.

Aspect 12. The method of aspect 11, wherein the molding comprises compression or injection molding.

Aspect 13. The aspect of claim 11 or 12, wherein said melt extrusion utilizes a screw extruder operating at a speed of at least 100 rpm.

Aspect 14. The method of any one of aspects 11-13, wherein the polymer comprises (i) 9.9 to 30 weight percent polycarbonate; (ii) 69.9 to 90 weight percent polymethyl methacrylate; and (iii) 0.0025 to 0.04 weight percent of catalyst, and wherein the combined weight percent value of all components does not exceed 100 wt. %, and wherein all weight percent values are based on the total weight of the polymer.

Aspect 15. The method of any one of aspects 11-14, wherein the polycarbonate comprises residues of bisphenol A.

Aspect 16. The method of any one of aspects 11-15, wherein the polycarbonate comprises less than or equal to 33 ppb of molybdenum; less than or equal to 33 ppb of vanadium; less than or equal to 33 ppb of chromium; less than or equal to 75 ppb of titanium; less than or equal to 375 ppb of niobium; less than or equal to 33 ppb of nickel; less than or equal to 10 ppb of zirconium; less than or equal to 10 ppb iron; or any combination of the foregoing.

Aspect 17. A method for forming a transparent polymer blend comprising melt extrusion of (i) 9.9 to 40 weight percent polycarbonate; (ii) 59.9 to 90 weight percent polymethyl methacrylate; and (iii) 0.0025 to 0.1 weight percent of catalyst, and wherein the combined weight percent value of all components does not exceed 100 wt. %, and wherein all weight percent values are based on the total weight of the transparent polymer blend.

Aspect 18. The method of aspect 17, wherein said melt extrusion utilizes a screw extruder operating at a speed of at least 100 rpm.

Aspect 19. The method of aspect 17 or 18, wherein said polycarbonate is substantially free of halogen atoms.

Aspect 20. The method of any one of aspects 17-19, wherein the polymer comprises (i) 9.9 to 30 weight percent polycarbonate; (ii) 69.9 to 90 weight percent polymethyl methacrylate; and (iii) 0.0025 to 0.04 weight percent of catalyst, and wherein the combined weight percent value of all components does not exceed 100 wt. %, and wherein all weight percent values are based on the total weight of the polymer.

Aspect 21. The method of any one of aspects 17-20, wherein the polymer additionally comprising one or more additives selected from flame retardants, anti-drip agent, antioxidant, antistatic agent, chain extender, colorant, de-molding agent, dye, flow promoter, flow modifier, light stabilizer, lubricant, mold release agent, pigment, quenching agent, thermal stabilizer, UV absorbent substance, UV reflectant substance, and UV stabilizer.

Aspect 22. The method of any one of aspects 17-21, wherein transesterification occurs with at least a portion of the polycarbonate and the polymethyl methacrylate during melt extrusion.

Aspect 23. The method of any one of aspects 17-22, wherein the polycarbonate comprises less than or equal to 33 ppb of molybdenum; less than or equal to 33 ppb of vanadium; less than or equal to 33 ppb of chromium; less than or equal to 75 ppb of titanium; less than or equal to 375 ppb of niobium; less than or equal to 33 ppb of nickel; less than or equal to 10 ppb of zirconium; less than or equal to 10 ppb iron; or any combination of the foregoing.

Aspect 24. The method of any one of aspects 17-23, further comprising molding the polymer blend into said article.

Aspect 25. An article comprising the transparent polymer blend of any one of aspects 1-10.

### EXAMPLES

The invention is illustrated by the following non-limiting examples. Unless otherwise stated to the contrary herein, all test standards are the most recent standard in effect at the time of filing this application.

In the following examples, MaxiGlas™ 888 (Maxiglas Corporation) was used as the polymethyl methacrylate polymer and SABIC™ PC Resin PC0703R (SABIC) was used as the polycarbonate polymer. Additional experiments were run using other PMMA polymers including MaxiGlas™ 515 (Maxiglass Corporation) and Acrypet™ VH 001 (Diapolyacrylate Company Limited) and polycarbonate polymers including LEXAN™ PC1000 (SABIC) and SABIC™ PC4800 (SABIC) with successful results.

### Comparative Example 1 and Examples 1-5

A polymer blend is formed by melt extrusion of (i) 9.9 to 30 weight percent polycarbonate; (ii) 69.9 to 90 weight percent polymethyl methacrylate; and (iii) 0 to 0.04 weight percent of dibutyl tin dilaurate catalyst. The resulting polymer was visually observed as to its transparency.

| | Comparative | | | | | |
|---|---|---|---|---|---|---|
| Composition | Example | Example 1 | Example 2 | Example 3 | Example 4 | Example 5 |
| PMMA | 90 | 89.99 | 89.98 | 89.96 | 79.96 | 69.96 |
| PC | 10 | 10 | 10 | 10 | 20 | 30 |
| DBTDL (di- | 0 | 0.01 | 0.02 | 0.04 | 0.04 | 0.04 |
| butyl tin | | | | | | |
| dilaurate) | | | | | | |
| Comments | Opaque | Transparent | Transparent | Transparent | Transparent | Transparent |

### Comparative Example 2 and Examples 6-7

Haze and transmission measurements were made on several samples. Transmittance (% T) and haze (% Haze) were measured according to ASTM D1003 at a thickness of 3.2 mm.

| | | % Haze | % T |
|---|---|---|---|
| Sample | Formulation Details | (@ 3.20 mm) | (@ 3.2 mm) |
| Comparative | Re-extruded 100% | 1.6 | 91.34 |
| Example 2 | PMMA | | |
| Example 6 | 80:20 PMMA:PC - no | 104.8 | 18.22 |
| | catalyst | | |
| Example 7 | 80:20 PMAA:PC - | 1.38 | 91.12 |
| | 400 ppm catalyst | | |

### Example 8

TEM analysis of several compositions was performed. Superior miscibility is seen with the blends that utilize catalyst as evidenced by the decreased segregation observed in the TEM images.

### Example 9

A transparent polymer blend is formed by melt extrusion of (i) 9.9 to 40 weight percent polycarbonate; (ii) 59.9 to 90 weight percent polymethyl methacrylate; and (iii) 0.0025 to 0.1 weight percent of dibutyl tin dilaurate catalyst.

### Example 10

The polymer blend of Example 9 is formed into a shaped article using compression molding.

### Example 11

A transparent polymer blend is formed by melt extrusion of (i) 9.9 to 30 weight percent polycarbonate; (ii) 69.9 to 90 weight percent polymethyl methacrylate; and (iii) 0.0025 to 0.04 weight percent of dibutyl tin dilaurate catalyst.

### Example 12

The polymer blend of Example 11 is formed into a shaped article using injection molding.

### Definitions

It is to be understood that the terminology used herein is for the purpose of describing particular aspects only and is not intended to be limiting. As used in the specification and in the claims, the term “comprising” can include the embodiments “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used herein, the term “polymer” includes polymers composed of a single species of a repeating unit (“homopolymer”) and polymers composed of a plurality of kinds of repeating units (so-called “copolymer”).

As used in the specification and the appended claims, the singular forms “a,” “an” and “the” include plural equivalents unless the context clearly dictates otherwise. Thus, for example, reference to “a polycarbonate polymer” includes mixtures of two or more polycarbonate polymers.

As used herein, the term “combination” is inclusive of blends, mixtures, alloys, reaction products, and the like.

Ranges can be expressed herein as from one particular value to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or the same. It is generally understood, as used herein, that it is the nominal value indicated ±5% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

References to parts by weight, of a particular element or component in a composition or article, denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

As used herein the terms “weight percent,” “wt. %,” and “wt. %” of a component, which can be used interchangeably, unless specifically stated to the contrary, are based on the total weight of the polymer blend in which the component is included. For example if a particular element or component in a composition or article is said to have 8% by weight, it is understood that this percentage is relative to a total compositional percentage of 100% by weight.

As used herein, the term “transparent” means that the level of transmittance for a disclosed composition is greater than 50%. In some embodiments, the transmittance can be at least 60%, 70%, 80%, 85%, 90%, or 95%, or any range of transmittance values derived from the above exemplified values. In the definition of “transparent”, the term “transmittance” refers to the amount of incident light that passes through a sample measured in accordance with ASTM D1003 at a thickness of 3.2 millimeters.

As used herein, the terms “transmittance” or “percent of transmittance” refer to the fraction of incident light at a specified wavelength that passes through a sample. Transmittance can be measured for a disclosed polymer in accordance with ASTM D1003.

The term “transesterification” is intended to include mechanisms of reaction that can occur between ester, alcohol and acid groups such as ester exchange and condensation reactions.

1. A transparent polymer blend comprising a polymer derived from melt extrusion of
(i) 9.9 to 40 weight percent polycarbonate;
(ii) 59.9 to 90 weight percent polymethyl methacrylate; and
(iii) 0.0025 to 0.1 weight percent of catalyst,
wherein said polymer is transparent.

2. The transparent polymer blend of claim 1, wherein the catalyst comprises tin.

3. The transparent polymer blend of claim 1, wherein the catalyst is dibutyl tin dilaurate.

4. The transparent polymer blend of claim 1, wherein said polycarbonate is substantially free of halogen atoms.

5. The transparent polymer blend of claim 1, wherein the polymer is derived from:
(i) 9.9 to 30 weight percent polycarbonate;
(ii) 69.9 to 90 weight percent polymethyl methacrylate; and
(iii) 0.0025 to 0.04 weight percent of catalyst.

6. The transparent polymer blend of claim 1, wherein transesterification occurs with at least a portion of the polycarbonate and the polymethyl methacrylate during melt extrusion.

7. The transparent polymer blend of claim 1, wherein the transparent polymer blend additionally comprises one or more of impact modifier, flow modifier, filler, reinforcing agent, antioxidant, heat stabilizer, light stabilizer, ultraviolet light stabilizer, ultraviolet absorbing additive, plasticizer, lubricant, release agent, antistatic agent, anti-fog agent, antimicrobial agent, colorant, surface effect additive, radiation stabilizer, flame retardant, and anti-drip agent.

8. The transparent polymer blend of claim 1, wherein the polycarbonate is derived from the melt polymerization of bisphenol A with diphenyl carbonate.

9. The transparent polymer blend of claim 1, wherein the polycarbonate comprises less than or equal to 33 ppb of molybdenum; less than or equal to 33 ppb of vanadium; less than or equal to 33 ppb of chromium; less than or equal to 75 ppb of titanium; less than or equal to 375 ppb of niobium; less than or equal to 33 ppb of nickel; less than or equal to 10 ppb of zirconium; less than or equal to 10 ppb iron; or any combination of the foregoing.

10. A method for forming a transparent polymer blend comprising melt extrusion of
(i) 9.9 to 40 weight percent polycarbonate;
(ii) 59.9 to 90 weight percent polymethyl methacrylate; and
(iii) 0.0025 to 0.1 weight percent of catalyst.

11. The method of claim 10, wherein said melt extrusion utilizes a screw extruder operating at least 100 rpm.

12. The method of claim 10, wherein said polycarbonate is substantially free of halogen atoms.

13. The method of claim 10, wherein the polymer comprises
(i) 9.9 to 30 weight percent polycarbonate;
(ii) 69.9 to 90 weight percent polymethyl methacrylate; and
(iii) 0.0025 to 0.04 weight percent of catalyst.

14. The method of claim 10, wherein transesterification occurs with at least a portion of the polycarbonate and the polymethyl methacrylate during melt extrusion.

15. The method of claim 10, further comprising molding the polymer blend into an article.
